(19) United States
(12) Patent Application Publication
(10) Pub. No.: US 2010/0095939 A1
(43) Pub. Date: Apr. 22, 2010

(54) GAS COOLER FOR AN INTERNAL COMBUSTION ENGINE

(76) Inventor: Peter GESKES, Ostfildern (DE)

Correspondence Address: Muncy, Geissler, Olds & Lowe, PLLC, P.O. BOX 1364, FAIRFAX, VA, 22038-1364, US

(21) Appl. No.: 12/550,047

(22) Filed: Aug. 28, 2009

(30) Foreign Application Priority Data
Aug. 28, 2008 (DE) DE102008044672.6

(51) Int. Cl. F02G 5/00; F28D 15/00; F01N 5/02; F02M 25/07

(52) U.S. Cl. 123/556; 165/104.28; 60/320; 123/568.12

(57) ABSTRACT

A gas cooler for an internal combustion engine is provided that includes a first heat exchanger having a plurality of flow channels which are cooled by a liquid coolant and through which compressed charge air flows in a main flow direction of the charge air, and includes a second heat exchanger having a plurality of flow channels which are cooled by the liquid coolant and through which exhaust gas from the internal combustion engine flows in a main flow direction of the exhaust gas, the first heat exchanger and the second heat exchanger being designed as a structurally integrated module, and the main flow direction of the charge air and the main flow direction of the exhaust gas forming an angle of more than 45°.

This nonprovisional application claims priority under 35 U.S.C. §119(a) to German Patent Application No. DE 10 2008 044 672.6, which was filed in Germany on Aug. 28, 2008, and which is herein incorporated by reference.

### BACKGROUND OF THE INVENTION

1. Field of the Invention

The invention relates to a gas cooler for an internal combustion engine.

2. Description of the Background Art

US 2006/0278377 A1 describes a module comprising an exhaust gas cooler and a charge air cooler, integrated into a common housing, for an internal combustion engine. The exhaust gas cooler and the charge air cooler are each provided with a stacked-plate design, a liquid coolant for removing heat from the compressed charge air and from the exhaust gas, which is recirculated for the purpose of reducing pollutants, flowing through the exhaust gas cooler and charge air cooler. The main flow directions of the exhaust gas and the charge air in the area of the cooled flow channels in the heat exchangers are parallel. The exhaust gas cooler is dimensioned to be much smaller in size than the charge air cooler, which at best permits only low exhaust gas recirculation rates.

### SUMMARY OF THE INVENTION

It is therefore an object of the present invention to provide a gas cooler for an internal combustion engine, which not only has a small and compact design, but also permits efficient cooling of both a charge air flow and an exhaust air flow at particularly high exhaust gas recirculation rates.

According to the invention, this object is achieved for a gas cooler, in which the main flow directions of the charge air and exhaust gas are arranged at an angle relative to each other, each of the gas flows may be cooled by making optimum use of the physical volume. This recognizes and utilizes, in particular, the fact that, due to the high exhaust gas pressure, the exhaust air flow may be particularly suitably cooled via a relatively small flow cross section of the exhaust gas cooler, at the same time a relatively long flow length of the exhaust gas in the main flow direction being desired, due to the high exhaust gas temperatures. In the case of the charge air, the heat exchanger design requirements are different, a maximum flow cross section and minimum flow length being desired in order to minimize the drop in charge air pressure over the heat exchanger.

In an embodiment, the main flow directions of the exhaust gas and charge air run substantially perpendicular to each other. However, the basic advantages of the gas cooler design may be used even if the flow directions form an angle of more than 45°.

Due to the aforementioned reasons, it is advantageously provided that a total flow cross section of the first heat exchanger can be larger that a total flow cross section of the second heat exchanger. According to an embodiment, the flow cross sections can differ from each other by a factor of at least 2. A total cross section is the total geometric cross section of the particular heat exchanger perpendicular to the particular main flow direction.

In an embodiment, it is also provided that a total flow length of the second heat exchanger, i.e. the exhaust gas cooler, can be greater than a total flow length of the first heat exchanger, i.e. the charge air cooler. In a preferred detail design, the flow length of the exhaust gas cooler is at least 1.3 times the flow length of the charge air cooler. The flow length can be understood to be a simple geometric length in the main flow direction over which heat is exchanged with the adjacent coolant. The definition of flow length does not take into account influences in the actual flow path, for example, turbulence generators such as ribs, dimples and the like.

To make optimum use of the physical volume, it is provided in an embodiment that after exiting the second heat exchanger the exhaust air flow empties into the charge air flow after exiting the first heat exchanger, in particular by conducting the exhaust air flow in a deflecting member. In the deflecting member, the exhaust air flow is suitably deflected by approximately 90° or by approximately 180°, depending on the embodiment. In the area of a deflecting member of this type, flow means may also be provided to produce selective turbulence or changes in direction in the exhaust air flow for the purpose of improved mixing with the charge air flow.

In an embodiment, the deflecting member can be disposed on the outlet side of the second heat exchanger in such a way that the exhaust gas is conducted to the charge air by the deflecting member. In a possible detail design, a tubular member or the like may be connected to the deflecting member in order to distribute the exhaust gas to the charge air flow as uniformly as possible, which is useful, in particular, in the case of short flow paths between the charge air cooler and intake valves.

In an alternative or supplementary embodiment of the invention, the deflecting member can be disposed between two flow paths of the second heat exchanger, in particular by providing the second heat exchanger as a U-flow heat exchanger. This makes it possible to achieve a great flow length and a relatively small flow cross section in the second heat exchanger, which is particularly suitable for cooling the exhaust air flow

In particular, for use with internal combustion engines in passenger cars whose operation frequently includes cold start phases, it is advantageously provided that the exhaust gas flow may be selectably conducted to the charge air flow by circumventing the second heat exchanger. A method for conducting the exhaust air flow by circumventing cooling corresponds to a bypass channel, which is used for cold start phases, in particular in order to avoid excessive precipitation of condensation in the exhaust gas cooler during the cold start phase.

In an embodiment, the actuator can be disposed on the inlet side of the second heat exchanger, which permits easy assembly. According to a simple design, the actuator may be, for example, an opening provided with a regulating flap in the wall of a common housing of the two heat exchangers.

In a further embodiment, at least the exhaust gas cooler has at least two separate grooves for liquid coolant. This makes it possible to cool the exhaust gas in multiple stages, e.g. in a first stage using a relatively warm coolant, e.g. from a main cooling circuit of the internal combustion engine, and in a second stage using a colder coolant, e.g. from a low-temperature cooling circuit. In principle, the first heat exchanger or charge air cooler may also be cooled in a similar two-stage manner.

In an embodiment, the liquid coolant can be supplied and/or discharged perpendicular to the two main flow directions. In an alternative embodiment, the liquid coolant may also be supplied and/or discharged parallel to the main flow direction of, for example, the exhaust gas. If necessary, a further deflection of the exhaust air flow in its supply area is suitable for this purpose.

Further, at least one of the heat exchangers can be designed as a stacked-plate heat exchanger. It can be advantageous to design both heat exchangers as stacked-plate heat exchangers. However, at least one of the heat exchangers, in particular both heat exchangers, may be alternatively or additionally designed as a tubular heat exchanger. In each of the possible designs, additional heat-transfer means such as ribbed plates, embossed dimples, winglets or the like may be provided in the known manner.

In a further embodiment, the first heat exchanger and the second heat exchanger can be designed as a soldered, integrated unit. This makes the manufacture of the heat exchanger particularly cost-effective and easy, e.g. by preassembling solder-plated sections and soldering both heat exchangers together in a soldering furnace. As an alternative, however, the first heat exchanger and the second heat exchanger may also be designed as separate components which are attached to each other, in particular, by seals. This makes it possible, for example, to design the exhaust gas cooler as an independently replaceable component which may under some circumstances be susceptible to contamination.

In an embodiment, a flow component can be disposed on the outlet side of at least one of the heat exchangers, the flow component making it possible to more thoroughly mix the exhaust gas with the charge air. A flow component of this type achieves effective mixing even in the event of a small physical volume or short flow paths. The flow component may include, for example, a distribution pipe disposed, for example, on the outlet side of the second heat exchanger or exhaust gas channel, whereby the one gas flows into the other gas at multiple points and is thereby distributed in space. Alternatively or in addition, the flow component may include a mixing screen, which achieves additional swirling and mixing of the previously combined gas flows.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic illustration of an internal combustion engine comprising an exhaust gas recirculation system which has a gas cooler according to the invention in a two-stage exhaust gas cooling process;

FIG. 2 shows the internal combustion engine from FIG. 1 having only single-stage exhaust gas cooling;

FIG. 3 shows a schematic spatial view of a first exemplary embodiment of a gas cooler;

FIG. 4 shows a schematic spatial view of a second exemplary embodiment of a gas cooler having an exhaust gas bypass function;

FIG. 4a shows a modification of the exemplary embodiment from FIG. 4;

FIG. 5 shows a third exemplary embodiment of a gas cooler having two separate coolant grooves in the exhaust gas cooler;

FIG. 6 shows a further exemplary embodiment of a gas cooler having an alternative coolant conducting system;

FIG. 7 shows a further exemplary embodiment of a gas cooler having a first embodiment of a flow component;

FIG. 8 shows a further exemplary embodiment of a gas cooler having a second embodiment of a flow component; and

FIG. 9 shows a further exemplary embodiment of a system of two heat exchangers.

### DETAILED DESCRIPTION

A gas cooler 1 according to the invention is integrated into the gas distribution system of an internal combustion engine 2 in such a way that exhaust gas of the engine is partially recirculated via a branch 3 and cooled in gas cooler 1, the main flow of the exhaust gas compressing or charging fresh air via an exhaust gas turbocharger 4. The charge air, which is compressed and heated by compression, is supplied to a first heat exchanger 1a of gas cooler 1, the branched exhaust air flow being supplied to a second heat exchanger 1b of gas cooler 1. Heat exchangers 1a, 1b are structurally integrated to form a single module. Gas cooler 1 is cooled by a liquid coolant, which is supplied or discharged via connections 5, 6. The coolant may be, for example, the coolant from the main cooling circuit of internal combustion engine 2 or coolant from a low-temperature cooling circuit provided separately therefrom.

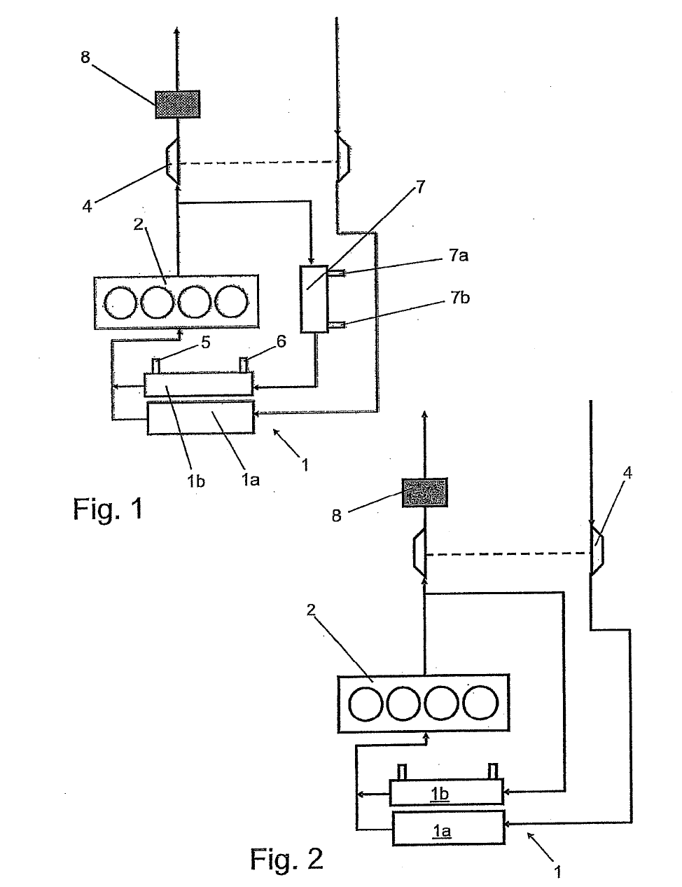

In the illustration according to FIG. 1, a further exhaust gas cooler 7 is provided upstream from second heat exchanger 1b to increase the overall cooling performance for the recirculated exhaust gas flow. Exhaust gas cooler 7 also has connections 7a, 7b for supplying or discharging a liquid coolant.

Downstream from the exhaust gas turbine of exhaust gas turbocharger 4, the exhaust gas flow, which is no longer being recirculated, also flows through a cleaning member 8, in particular a particle filter or an oxidation catalytic converter.

FIG. 2 show a variant of the system described above, in which the only difference is that no additional exhaust gas cooler 7 is provided. Accordingly, the exhaust gas cooler or second heat exchanger 1b must be provided with a particularly efficient design.

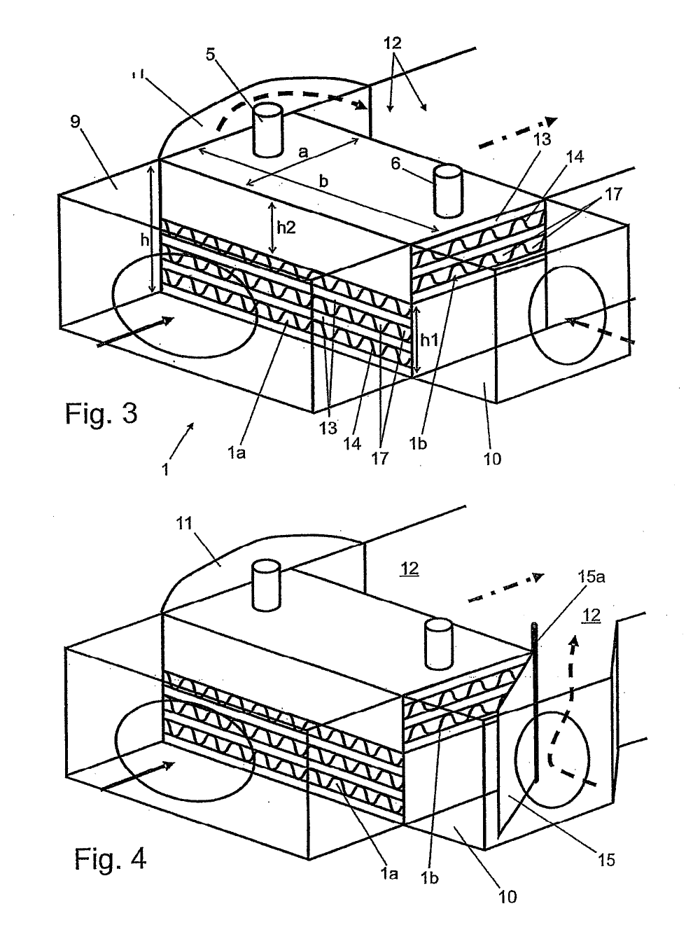

A first embodiment of a gas cooler according to the invention is illustrated in detail in FIG. 3. Gas cooler 1 is designed as a heat exchanger of stacked-plate construction, an envelope of the gas cooler having an essentially rectangular shape of a length a, a height h and a width b. A lower portion of gas cooler 1 in relation to height direction h is designed as a first heat exchanger 1a of height h1, charge air flowing through this first heat exchanger. A second heat exchanger 1b, which is mounted directly thereupon and is firmly bonded thereto, in particular by soldering together, is used to cool the recirculated exhaust gas flow and has height h2. At least in an idealized view, h=h1+h2.

According to the drawing in FIG. 3, the charge air flows in a main flow direction which is perpendicular to the side of the heat exchanger defined by height direction h and width direction b. The charge air flow is indicated by a solid direction arrow. A supplying accumulator 9 for the charge air is shown on the inlet side of heat exchanger 1a.

The exhaust gas flow is indicated by broken arrows and flows through gas cooler 1 in a main flow direction which is located perpendicular to the side of the heat exchanger which is spanned by height direction h and length direction a and runs parallel to width direction b. An accumulator 10 for the exhaust gas flow is also sketched on the inlet side.

The two main flow directions of exhaust gas and charge air are thus oriented perpendicular to each other.

Coolant supply connections 5, 6 are oriented perpendicular to the main flow directions of the exhaust gas and charge air. Gas cooler 1 is designed as a stacked-plate heat exchanger with regard to both first heat exchanger 1a and second heat exchanger 1b, the coolant channels connecting to connections 5, 6 passing through heat exchangers 1a, 1b in the manner of channels provided by passages in the stacked plates. Coolant flows through the spaces between adjacent stacked plates in the known manner on the way from the supplying coolant channel to the discharging coolant channel, thereby cooling a wide area of the stacked plates.

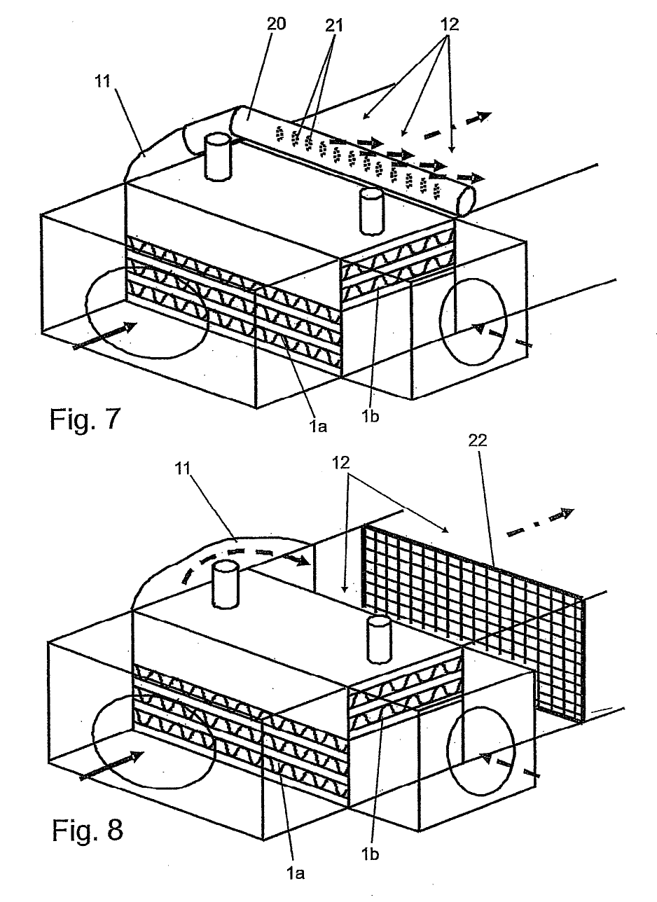

A deflecting member 11, which deflects the cooled exhaust gas flow by approximately 180° and enables it to empty into the cooled charge air flow on the outlet side in a mixing area 12, is disposed on the outlet side of the second heat exchanger for the exhaust gas. An optional flow component may be provided on the outlet side of deflecting member 11 (see description of FIG. 7 and FIG. 8 below) in order to optimally mix the exhaust gas flow with the charge air flow.

Without being true to scale, the drawing of the exemplary embodiment in FIG. 3 clearly shows that the flow length of the exhaust gas flow, which in this example largely corresponds to width b, is much greater than the flow length of the charge air flow, which in this example largely corresponds to length a.

First heat exchanger 1a has a mounting height h1 and second heat exchanger 1b has a mounting height h2, which together add up approximately to overall height h of the heat exchanger. A total flow cross section of the first heat exchanger results in approximately h1*b, no deductions being made for coolant-conducting plates 13 and heat-transferring rib members 14. Flow channels 17, through which charge air or exhaust gas flow, remain between plates 13 and ribs 14. The total flow cross section of the exhaust gas cooler therefore results in approximately h2*a. In each of the illustrated exemplary embodiments, the flow cross section of the first heat exchanger is substantially larger than the flow cross section of the second heat exchanger; in the present exemplary embodiment, it is more than twice as large. Conversely, the flow length of the second heat exchanger is greater than the flow length of the first heat exchanger; in the present example, it is more than 1.3 times as long.

The overall result of this is that the dimensioning of charge air cooler 1a and exhaust gas cooler 1b optimally complement each other with regard to the physical volume occupied by each unit, the charge air undergoing a slight drop in pressure, due to the large flow cross section and the short flow length, and at the same time the exhaust gas undergoing a relatively great drop in pressure, due to the great flow length and small flow cross section, at the same time being effectively cooled.

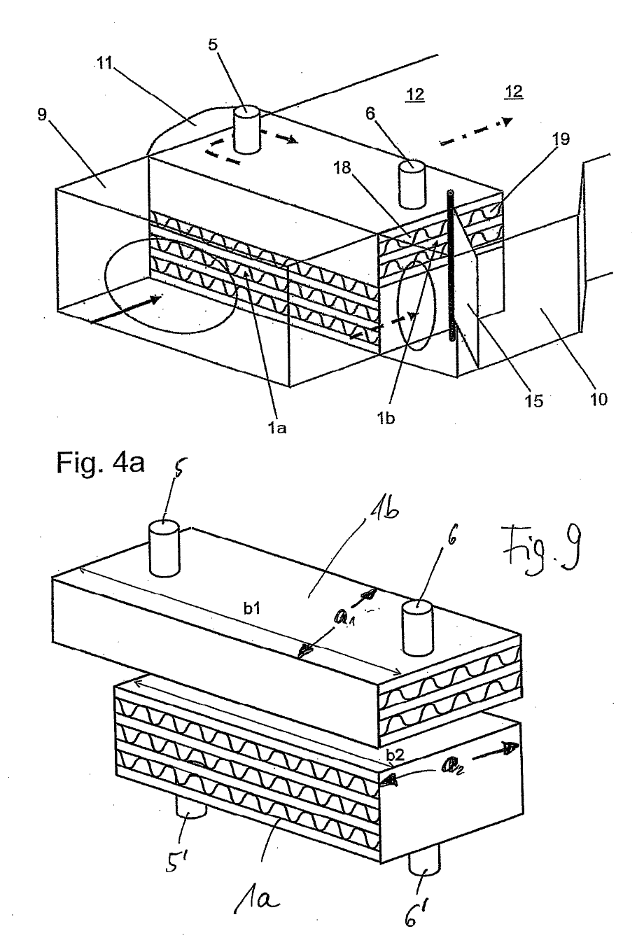

In the second exemplary embodiment according to FIG. 4, a modification of the gas cooler from FIG. 3 is shown, in which the main difference is that an actuator 15 in the manner of a bypass flap is provided in the area of inlet-side accumulator 10 of exhaust gas cooler 1b. Depending on the position of actuator 15, the recirculated exhaust gas flow illustrated in FIG. 4 may be conducted past exhaust gas cooler 1b to mixing area 12 or to the cooled charge air flow during a cold start phase of the internal combustion engine. Upon reaching the operating temperature, actuator 15 is rotated around a rotary shaft 15a, and the exhaust gas flow then flows completely through exhaust gas cooler 1b.

In the modification illustrated in FIG. 4a of the example from FIG. 4, deflecting member 11 does not empty into mixing area 12, but into a recirculating, cooled flow channel 19 of second heat exchanger 1b, so that, with regard to the exhaust gas flow, the deflecting member is disposed between first flow path 18 and second flow path 19 of exhaust gas cooler s. As a result, the exhaust gas cooler is designed at least on the gas side as a U-flow heat exchanger having two anti-parallel flow paths 18, 19. Accumulator 10 has a regulating flap 15, which is mounted on a partition wall (not illustrated) of flow channels 18, 19 and, depending on its position, initiates a bypass operation (not shown) or a flow throw the U-flow heat exchanger.

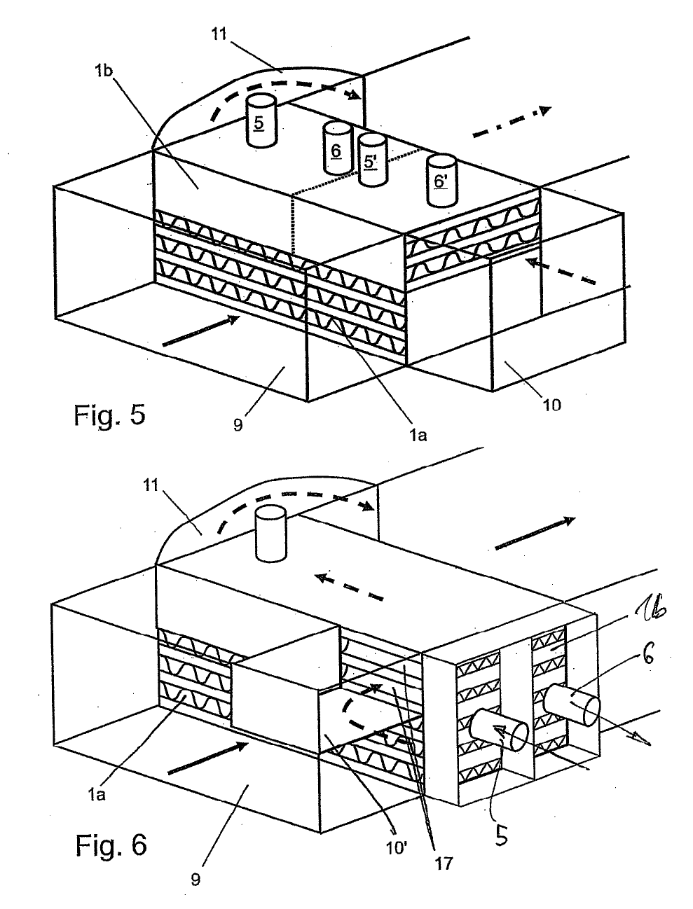

In the modification illustrated in FIG. 5 of the exemplary embodiment from FIG. 3, four connections 5, 6, 5′, 6′ are provided for liquid coolant instead of only two connections, whereby two of connections 5, 6, 5′, 6′ belong to a separate coolant groove. In this manner, it is possible, for example, for the first groove in the direction of exhaust gas flow, which has connections 5′, 6′, to conduct a coolant of a higher temperature, e.g., connected to the main cooling circuit of the internal combustion engine, while a colder coolant, e.g., from a separate low-temperature cooling circuit, flows through the subsequent second groove having connections 5, 6. In principle, it is also possible to provide the charge air cooler with separate grooves or connections for a liquid coolant or, as in the illustrated exemplary embodiment, to have only the colder coolant from connections 5, 6 flow through charge air cooler 1a, which is particularly simple and suitable with regard to the temperatures of the charge air.

FIG. 6 shows a further exemplary embodiment, in which connections 5, 6 for the liquid coolant are not attached on the upper side and perpendicular to the two main flow directions of the charge air and exhaust gas, but instead are attached on the side, so that the inflow and outflow of the liquid coolant each takes place parallel to the main flow direction of the exhaust gas and perpendicular to the main flow direction of the charge air. This requires additional means for conducting the exhaust gas, for which purpose an accumulator 10′, which deflects the exhaust gas flow by 90°, is provided for the exhaust gas in an edge area of the accumulator for supplying charge air 9. After entering actual heat exchanger area 1b, the exhaust gas is again deflected by 90° in the opposite direction, so that the exhaust gas as a whole undergoes a more or less Z-shaped deflection in the entry area.

A further exemplary embodiment according to FIG. 7 is essentially a modification of the exemplary embodiment from FIG. 3, in which a flow component in the form of a distribution pipe 20 is provided downstream from deflecting member 11 on the outlet side of second heat exchanger 1b. Distribution pipe 20 is connected to deflecting member 11 and extends largely over the width of the charge air flow on the outlet side of first heat exchanger 1a. A plurality of openings 21 are distributed over the length of distribution pipe 20, so that the exhaust gas flow is introduced into the charge air flow over a spatially distributed mixing area 12.

In this case, distribution pipe 20 is disposed on the outside of the housing of the charge air flow. However, it may alternatively be provided within the housing.

In the exemplary embodiment according to FIG. 8, a flow component 22 is also provided as a supplement to the exemplary embodiment from FIG. 3 for the purpose of improving the mixing of the gas flows. Flow component 22 is designed as a mixing screen 23, which largely extends over the entire cross section of the combined gas channel after the exhaust gas empties into the charge air. The mixing screen introduces eddies into the combined, but still partially inhomogeneous gas flow, these eddies ensuring a good homogenization over a short flow length.

It is understood that a distribution pipe 20 and a mixing screen 22 may also be supplementary. In addition, these or other flow components may also be combined with the other exemplary embodiments.

In a not illustrated exemplary embodiment the gas cooler is integrated into an intake module of the internal combustion engine, it being possible for this intake module to be made of aluminum or plastic.

The internal combustion engine is a diesel engine or another supercharged engine with the possibility of exhaust gas recirculation, for example a direct-injection spark ignition engine.

It is understood that the individual features of the individual exemplary embodiments may be combined with each other, depending on the requirements.

FIG. 9 shows a schematic system of two heat exchangers 1a, 1b according to an alternative embodiment of the systems illustrated in the preceding figures.

Heat exchanger 1a and heat exchanger 1b do not necessarily have to touch, as shown in FIG. 9. FIG. 9 also shows that the dimensions of the two heat exchangers 1a, 1b, like length b1 and length b2 of the two heat exchangers 1a, 1b, are not identical. Once again, it is not absolutely necessary for depths a1, a2 of the two heat exchangers 1a, 1b to be the same.

In the event that the two heat exchangers are not in direct contact with each other, connectors 5, 6, 5′, 6′ must be provided on each heat exchanger. These connectors are shown in FIG. 9 on the upper side of heat exchanger 1b and on the lower side of heat exchanger 1a.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A gas cooler for an internal combustion engine, the gas cooler comprising:
a first heat exchanger having a plurality of flow channels that are configured to be cooled by a liquid coolant and configured such that compressed charge air flows therethrough in a main flow direction of the charge air; and
a second heat exchanger having a plurality of flow channels that are configured to be cooled by the liquid coolant and configured such that exhaust gas from the internal combustion engine flows therethrough in a main flow direction of the exhaust gas,
wherein the first heat exchanger and the second heat exchanger are configured as a structurally integrated module, and
wherein the main flow direction of the charge air and the main flow direction of the exhaust gas form an angle with respect to one another of more than 45°.

2. The gas cooler according to claim 1, wherein the main flow direction of the exhaust gas and the main flow direction of the charge air are substantially perpendicular to each other.

3. The gas cooler according to claim 1, wherein a total flow cross section of the first heat exchanger is larger than a total flow cross section of the second heat exchanger or wherein the total flow cross section of the first heat exchanger is larger than the total flow cross section of the second heat exchanger by a factor of at least 2.

4. The gas cooler according to claim 1, wherein a total flow length of the second heat exchanger is greater than a total flow length of the first heat exchanger, or wherein the total flow length of the second heat exchanger is greater than the total flow length of the first heat exchanger by a factor of at least 1.3.

5. The gas cooler according to claim 1, wherein, after exiting the second heat exchanger, the exhaust gas flow empties into the charge air flow after exiting the first heat exchanger by conducting the exhaust gas flow via a deflecting member.

6. The gas cooler according to claim 5, wherein the deflecting member is disposed on an outlet side of the second heat exchanger.

7. The gas cooler according to claim 5, wherein the deflecting member is disposed between two flow paths of the second heat exchanger, and wherein the second heat exchanger is configured as a U-flow heat exchanger.

8. The gas cooler according to claim 1, wherein the exhaust gas is selectably conducted to the charge air flow by an actuator circumventing the second heat exchanger.

9. The gas cooler according to claim 8, wherein the actuator is disposed on an inlet side of the second heat exchanger.

10. The gas cooler according to claim 1, wherein at least the exhaust gas cooler has at least two separate grooves for liquid coolant.

11. The gas cooler according to claim 1, wherein the liquid coolant is supplied and/or discharged substantially perpendicular to the main flow directions of the charge air and the exhaust gas.

12. The gas cooler according to claim 1, wherein the liquid coolant is supplied and/or discharged substantially parallel to the main flow direction of the exhaust gas.

13. The gas cooler according to claim 1, wherein at least one of the first or second heat exchangers is configured as a stacked-plate heat exchanger.

14. The gas cooler according to claim 1, wherein at least one of the first or second heat exchangers is configured as a tubular heat exchanger.

15. The gas cooler according to claim 1, wherein the first heat exchanger and the second heat exchanger are a soldered and integrated unit.

16. The gas cooler according to claim 1, wherein the first heat exchanger and the second heat exchanger are configured as separate components that are attachable to each other by seals.

17. The gas cooler according to claim 1, further comprising a flow component on an outlet side of at least one of the first or second heat exchangers, the flow component configured to mix the exhaust gas with the charge air.

18. The gas cooler according to claim 17, wherein the flow component includes a distribution pipe that is disposed on an output side of the second heat exchanger.

19. The gas cooler according to claim 17, wherein the flow component includes a mixing screen.
